(19) United States
(12) Patent Application Publication
(10) Pub. No.: US 2025/0053176 A1
(43) Pub. Date: Feb. 13, 2025

(54) METHOD AND APPARATUS FOR CONTROLLING TRAVELLING OF VEHICLE PLATOON, DEVICE, AND STORAGE MEDIUM

(71) Applicant: TENCENT TECHNOLOGY (SHENZHEN) COMPANY LIMITED, Shenzhen (CN)

(72) Inventor: Yixue Lei, Shenzhen (CN)

(73) Assignee: TENCENT TECHNOLOGY (SHENZHEN) COMPANY LIMITED, Shenzhen (CN)

(21) Appl. No.: 18/928,273

(22) Filed: Oct. 28, 2024

Related U.S. Application Data
(63) Continuation of application No. PCT/CN2022/142508, filed on Dec. 27, 2022.

(30) Foreign Application Priority Data
May 18, 2022 (CN) 202210550989.8

(51) Int. Cl. G05D 1/227; G05D 1/698; G05D 109/10; G05D 111/30; G08G 1/00

(52) U.S. Cl. CPC G05D 1/227; G05D 1/698; G08G 1/22; G05D 2109/10; G05D 2111/32

(57) ABSTRACT

A method for controlling travelling of a vehicle platoon includes: establishing, by a target vehicle of the vehicle platoon, a network connection with a remote control terminal; determining, by the target vehicle, that the target vehicle is to be remotely taken over; initiating, by the target vehicle, control of statuses of vehicles of the vehicle platoon other than the target vehicle; transmitting, by the target vehicle, a takeover request to the remote control terminal, controlling, by the remote control terminal, the target vehicle to enter a driving state; and receiving, by the target vehicle, a takeover confirmation message transmitted by the remote control terminal, wherein the vehicles include a leading vehicle (LV) and a following vehicle (FV) of the LV.

### CROSS-REFERENCE TO RELATED APPLICATIONS

This application is a continuation application of International Application No. PCT/CN2022/142508 filed on Dec. 27, 2022, which claims priority to Chinese Patent Application No. 202210550989.8, filed with the China National Intellectual Property Administration on May 18, 2022, the disclosures of each being incorporated by reference herein in their entireties.

### FIELD

The disclosure relates to the field of computers and communication technologies, and in particular, to a method and an apparatus for controlling travelling of a vehicle platoon, a device, and a storage medium.

### BACKGROUND

Vehicle platooning refers to enabling two or more vehicles to closely follow and be connected to each other based on a wireless communication technology and an autonomous driving technology to form a platoon with vehicles performing similar driving behaviors. Three types of vehicles exist in a vehicle platooning scenario: a leading vehicle (LV), a following vehicle (FV), and a free vehicle. The LV is a front-most vehicle of a vehicle platoon in a travelling direction of the vehicle platoon during driving as a platoon, which is responsible for management of the entire vehicle platoon. The FV is an FV other than the LV during driving as a platoon of vehicles. The free vehicle is a vehicle outside the vehicle platoon. The free vehicle is not located in the vehicle platoon, and therefore does not perform a driving behavior or a data exchange operation related to platooning with the LV or the FV.

In the related art, vehicles of a vehicle platoon communicate with each other through a near-field direct communication interface, and driving as a platoon and management are independently completed by the vehicle platoon. How to control statuses of the vehicles of the vehicle platoon based on a target vehicle (for example, the LV or an FV) of the vehicle platoon encountering an emergency or requiring travelling intervention is a problem that needs to be resolved urgently.

### SUMMARY

Provided are a method and an apparatus for controlling travelling of a vehicle platoon, a device, and a storage medium, which can realize remote control of statuses of vehicles of a vehicle platoon through a network, and perform flexible remote scheduling on the vehicle platoon.

According to some embodiments, a method for controlling travelling of a vehicle platoon includes: establishing, by a target vehicle of the vehicle platoon, a network connection with a remote control terminal; determining, by the target vehicle, that the target vehicle is to be remotely taken over; initiating, by the target vehicle, control of a plurality of statuses of a plurality of vehicles of the vehicle platoon other than the target vehicle; transmitting, by the target vehicle, a takeover request to the remote control terminal, controlling, by the remote control terminal, the target vehicle to enter a driving state; and receiving, by the target vehicle, a takeover confirmation message transmitted by the remote control terminal, wherein the plurality of vehicles include a leading vehicle (LV) and a following vehicle (FV) of the LV.

According to some embodiments, an apparatus for controlling travelling of a vehicle platoon includes: at least one memory configured to store computer program code; and at least one processor configured to read the program code and operate as instructed by the program code, the program code including: connection code, configured to cause at least one of the at least one processor to establish network connection with a remote control terminal; processing code, configured to cause at least one of the at least one processor to: determine that a target vehicle of the vehicle platoon is to be remotely taken over; and initiate control of a plurality of statuses of a plurality of vehicles of the vehicle platoon other than the target vehicle; first transmission code, configured to cause at least one of the at least one processor to transmit a takeover request to the remote control terminal; and first receiving code, configured to cause at least one of the at least one processor to receive a takeover confirmation message transmitted by the remote control terminal, wherein the remote control terminal is configured to control the target vehicle to enter a driving state based on the takeover request, and wherein the plurality of vehicles include a leading vehicle (LV) and a following vehicle (FV) of the LV.

According to some embodiments, a non-transitory computer-readable storage medium, storing computer code which, when executed by at least one processor, causes the at least one processor to at least: establish network connection with a remote control terminal; determine that a target vehicle of a vehicle platoon is to be remotely taken over; initiate control of a plurality of statuses of a plurality of vehicles of the vehicle platoon other than the target vehicle; transmit a takeover request to the remote control terminal; and receive a takeover confirmation message transmitted by the remote control terminal, wherein the remote control terminal is configured to control the target vehicle to enter a driving state based on the takeover request, and wherein the plurality of vehicles include a leading vehicle (LV) and a following vehicle (FV) of the LV

### BRIEF DESCRIPTION OF THE DRAWINGS

To describe the technical solutions of some embodiments of this disclosure more clearly, the following briefly introduces the accompanying drawings for describing some embodiments. The accompanying drawings in the following description show only some embodiments of the disclosure, and a person of ordinary skill in the art may still derive other drawings from these accompanying drawings without creative efforts. In addition, one of ordinary skill would understand that aspects of some embodiments may be combined together or implemented alone.

FIG. 1 is a schematic diagram of an application scenario according to some embodiments.

FIG. 2 is an interaction flowchart of a method for controlling travelling of a vehicle platoon according to some embodiments.

FIG. 3 is an interaction flowchart of a method for controlling travelling of a vehicle platoon according to some embodiments.

FIG. 4 is a system architecture diagram of a method for controlling travelling of a vehicle platoon according to some embodiments.

FIG. 5 is an interaction flowchart of a method for controlling travelling of a vehicle platoon according to some embodiments.

FIG. 6 is an interaction flowchart of a method for controlling travelling of a vehicle platoon according to some embodiments.

FIG. 7 is an interaction flowchart of a method for controlling travelling of a vehicle platoon according to some embodiments.

FIG. 8 is an interaction flowchart of a method for controlling travelling of a vehicle platoon according to some embodiments.

FIG. 9 is a schematic structural diagram of an apparatus for controlling travelling of a vehicle platoon according to some embodiments.

FIG. 10 is a schematic structural diagram of an apparatus for controlling travelling of a vehicle platoon according to some embodiments.

FIG. 11 is a schematic block diagram of an electronic device according to some embodiments.

### DESCRIPTION OF EMBODIMENTS

To make the objectives, technical solutions, and advantages of the present disclosure clearer, the following further describes the present disclosure in detail with reference to the accompanying drawings. The described embodiments are not to be construed as a limitation to the present disclosure. All other embodiments obtained by a person of ordinary skill in the art without creative efforts shall fall within the protection scope of the present disclosure.

In the following descriptions, related “some embodiments” describe a subset of all possible embodiments. However, it may be understood that the “some embodiments” may be the same subset or different subsets of all the possible embodiments, and may be combined with each other without conflict. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. For example, the phrase “at least one of A, B, and C” includes within its scope “only A”, “only B”, “only C”, “A and B”, “B and C”, “A and C” and “all of A, B, and C.”

Terms “first,” “second,” and the like, are intended to distinguish between similar objects, rather than describe a specific sequence or order. Data may be transposed as appropriate, so that some embodiments described herein may be implemented in a sequence different from the sequence shown or described herein. Moreover, terms “include” and “have” and any variations are intended to cover non-exclusive inclusion. For example, a process, a method, a system, a product, or a device that includes a list of operations or units is not necessarily limited to those expressly listed operations or units, and may include other operations or units not expressly listed or inherent to such the process, the method, the product, or the device.

Explanations related to the disclosure are briefly provided below.

1. Artificial Intelligence (AI for short): It is a theory, a method, a technology, and an application system that use a digital computer or a machine controlled by the digital computer to simulate, extend, and expand human intelligence, to sense an environment, acquire knowledge, and obtain a result with knowledge. The AI is a large technology in computer science, which attempts to understand the essence of intelligence and produce a new intelligent machine that may react in a manner similar to human intelligence. The AI is to study the design principles and implementation methods of various intelligent machines, to enable the machines to have functions of sensing, reasoning, and decision-making.

The AI technology is a large discipline, and it involves a wide range of fields including both hardware-level technologies and software-level technologies. AI technologies include technologies such as a sensor, a dedicated AI chip, cloud computing, distributed storage, a big data processing technology, an operating/interaction system, and electromechanical integration. AI software technologies may include major directions such as a computer vision technology, a speech processing technology, a natural language processing technology, and machine learning/deep learning.

With study and progress of the AI technology, the AI technology has been studied and applied in many fields, such as common smart home, smart wearable devices, virtual assistants, smart speakers, smart marketing, unmanned driving, automatic driving, unmanned aerial vehicles, robots, and smart customer service.

An autonomous driving technology usually includes technologies such as a high-precision map, environmental sensing, behavioral determination, path planning, and motion control. The autonomous driving technology has broad application prospects.

2. Platooning: It refers to enabling two or more vehicles to closely follow and be connected to each other based on a wireless communication technology and an autonomous driving technology to form a platoon with vehicles performing similar driving behaviors.

3. Driving as a platoon: It is a process of enabling two or more vehicles to travel in a form of a platoon in a scenario, which includes platooning behaviors such as creating a platoon, dismissing a platoon, joining a platoon, and leaving a platoon.

4: Leading vehicle (LV for short): It is a front-most vehicle of a platoon in a travelling direction of the platoon during driving as a platoon, which is responsible for management of the entire platoon.

5: Following vehicle (FV for short): It is an FV other than the LV during driving as a platoon.

Some embodiments may involve technologies such as the autonomous driving of the AI.

In some embodiments, a status of a vehicle may include “a leading state,” “a following state,” and “a free state.” An LV is in the leading state, an FV is in the following state, and a vehicle not involved in driving as a platoon of vehicles is in the free state (a corresponding vehicle may be referred to as a free vehicle).

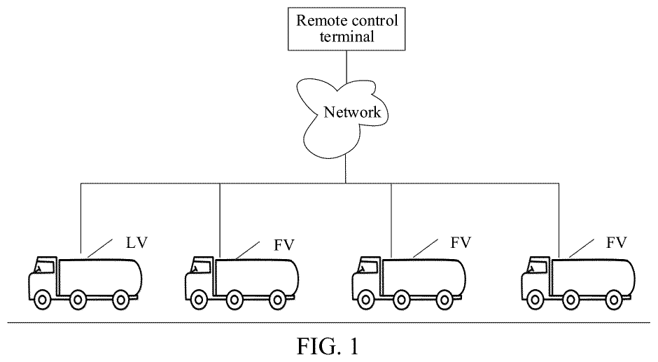

For example, FIG. 1 is a schematic diagram of an application scenario according to some embodiments. As shown in FIG. 1, some embodiments may involve a remote control terminal, a network, and a controlled vehicle. The controlled vehicle may include any vehicle of a vehicle platoon. The remote control terminal may be deployed on a cloud server. The cloud server may include a central cloud server or an edge cloud server (mobile edge computing (MEC for short)). The edge cloud server is a server located closer to an edge end. For example, the edge cloud server is arranged on a road side, to provide services for a nearby range. Different from the edge cloud server, the central cloud server is arranged on a distal end, which may provide services for a wider range.

A plurality of vehicles form a vehicle platoon. An LV may communicate with an FV. The LV may transmit sensor data to the FV. The LV may transmit a sensor data obtaining request to the FV to obtain data sensed by the FV. The LV and the FV may communicate with the remote control terminal through the network. The network may be, for example, a 4th generation mobile communication technology (4G) network, a 5th generation mobile communication technology (5G) network, or a next-generation wireless communication network.

In some embodiments, the remote control terminal may obtain status information of each vehicle of the vehicle platoon. The status information, for example, may include status parameters and other attribute information of the vehicle obtained through a vehicle sensor, and may further include fused sensing information obtained by fusing data of a plurality of vehicle sensors. The data fusion includes but is not limited to processing sensing data based on aligned time and spatial coordinates to obtain more accurate and comprehensive information. In the scenario shown in FIG. 1, each FV may transmit status information thereof to the LV, and then the LV transmits the status information to the remote control terminal through the network. Alternatively, each vehicle may transmit the status information thereof to the remote control terminal through the network. Based on receiving the status information of each vehicle, the remote control terminal may dismiss the vehicle platoon based on the status information of each vehicle, or may determine, by matching, vehicles that may form a vehicle platoon. A matching range is not limited to a ProSe Communication 5 (PC5) communication range. The remote control terminal may find a suitable platoon for a free vehicle (for example, a vehicle that is not a member of a platoon) based on information such as a planned travelling route of the vehicle, capabilities of supporting remote control driving and driving as a platoon, and vehicle platoon service authorization, and trigger a platoon joining process. Alternatively, the remote control terminal may take over a vehicle of a vehicle platoon encountering an emergency, and remotely control statuses of other vehicles of the vehicle platoon through the network, to realize flexible control of the vehicle platoon. For example, the remote control terminal dismisses the vehicle platoon, and controls the other vehicles to become free vehicles.

Vehicles of a vehicle platoon may exchange information with and respond to each other through a vehicle to everything (V2X) communication device, to implement platoon control decision-making, and satisfy a demand for driving as a platoon. In addition, information exchange may be performed between the vehicles and the remote control terminal, to realize control and management of the platoon, such as obtaining of real-time status information, instruction inputting and outputting, and emergency control. The vehicles may transmit information to a road side unit (RSU), including a dynamic speed limit, a traffic condition, and the like, to achieve vehicle infrastructure cooperation.

The LV is a front-most vehicle of the vehicle platoon, and is a decision-maker for a travelling behavior of the entire vehicle platoon, which performs control and decision-making on behaviors of the platoon. The LV may be driven manually by a driver, or may be driven automatically. The LV has functions of recording and sharing a driving behavior in real-time, properly planning a travelling route and a travelling behavior based on a traffic condition, and performing a driving behavior effectively and accurately. The LV exchanges information with the FV through the V2X communication device, to deliver travelling parameter information thereof such as a trajectory and a status to the FV.

The FV may be driven automatically by a system. The FV has capabilities of properly planning a travelling route and a travelling behavior based on a traffic condition and effectively and accurately executing the travelling parameters transmitted by the LV. The FV exchanges information with the LV and other FVs through the V2X communication device and records the information, and transmits location information, status information, and the like thereof to other vehicles of the vehicle platoon.

To control statuses of the vehicles of the vehicle platoon based on a target vehicle (for example, the LV or an FV) of the vehicle platoon encountering an emergency or requesting travelling intervention, in some embodiments, the remote control terminal establishes network connection with each vehicle of the vehicle platoon, so that the remote control terminal may obtain the status information of each vehicle of the vehicle platoon. Based on the target vehicle determining the target vehicle is to be remotely taken over, the target vehicle initiates the operation of controlling the statuses of the vehicles of the vehicle platoon other than the target vehicle, and transmits the takeover request to the remote control terminal through the network, so that the remote control terminal may control the target vehicle to enter the driving state. Based on the target vehicle of the vehicle platoon being determined to be remotely taken over (for example, the target vehicle determines the target vehicle is to be remotely taken over based on encountering an emergency or requesting travelling intervention), the target vehicle requests the remote control terminal to control the target vehicle to enter the driving state, and initiates the operation of controlling the statuses of the other vehicles of the vehicle platoon. In this way, remote control of the statuses of the vehicles of the vehicle platoon through the network may be realized, so that the remote control terminal may perform flexible remote scheduling on the vehicle platoon, and the remote control terminal may control a driving behavior of the vehicle platoon and perform platoon management in real time, and may perform remote intervention on the vehicle platoon. A method for controlling travelling of a vehicle platoon provided in some embodiments is described in detail below with reference to the drawings.

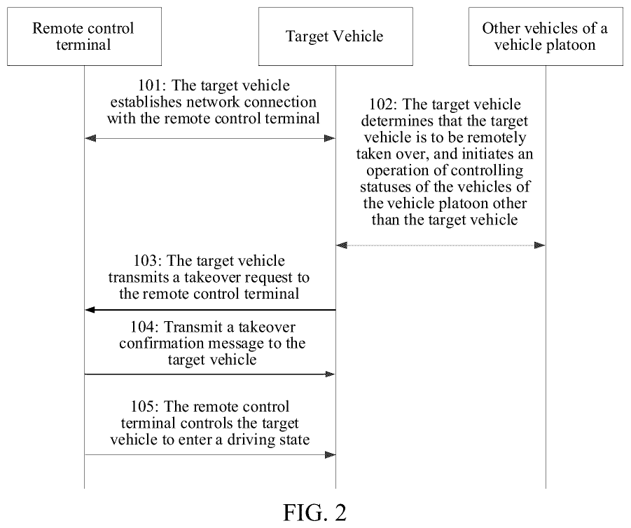

FIG. 2 is an interaction flowchart of a method for controlling travelling of a vehicle platoon according to some embodiments. As shown in FIG. 2, the method may include the following operations:

101: A target vehicle establishes network connection with a remote control terminal, the target vehicle being any vehicle of the vehicle platoon.

The target vehicle is any vehicle of the vehicle platoon. Members of the vehicle platoon include an LV and an FV of the LV. The LV may be driven manually by a driver, or may be driven automatically. In the vehicle platoon, the LV performs V2X communication with the FV in a PC5 communication manner for driving as a platoon.

That the target vehicle establishes the network connection with the remote control terminal may be that the target vehicle establishes the network connection through a 4G network, a 5G network, or a next-generation wireless communication network. Based on establishing the network connection, the target vehicle may exchange data with the remote control terminal. In some embodiments, the method in some embodiments may further include:
transmitting, by the target vehicle, status information of the target vehicle to the remote control terminal. The status information, for example, may include status parameters and other attribute information of the vehicle obtained through a vehicle sensor, and may further include fused sensing information obtained by fusing data of a plurality of vehicle sensors. The data fusion includes but is not limited to processing sensing data based on aligned time and spatial coordinates to obtain more accurate and comprehensive information. The status information, for example, may include a current travelling speed and current location information.

102: The target vehicle determines the target vehicle is to be remotely taken over, and initiates an operation of controlling statuses of vehicles of the vehicle platoon other than the target vehicle.

For example, the target vehicle determining that the target vehicle is to be remotely taken over may be based on the target vehicle determining the target vehicle is encountering an emergency or requesting travelling intervention, or it may be based on the target vehicle determining the target vehicle is having difficulty in further travelling, the target vehicle is having a malfunction or is low on fuel, or a driver of the LV is experiencing discomfort based on the target vehicle being the LV.

Based on the target vehicle determining the target vehicle is to be remotely taken over, the vehicle platoon changes accordingly. The operation of controlling the statuses of the vehicles of the vehicle platoon other than the target vehicle is initiated, to control the statuses of the other vehicles of the vehicle platoon.

In some embodiments, based on the target vehicle being the LV, the target vehicle initiating an operation of controlling statuses of vehicles of the vehicle platoon other than the target vehicle may include the following operation:

1021: The target vehicle transmits, based on the target vehicle determining the vehicle platoon is to be dismissed, a platoon dismissing message to the FV of the LV, so that the FV that receives the platoon dismissing message sets a status of the FV to a free state, and travels out of vehicle platoon.

For example, because the LV being taken over may be caused by a special status of the LV, the LV may be no longer suitable for travelling as an LV. The vehicle platoon may be dismissed. Based on the LV determining the vehicle platoon is to be dismissed, the LV transmits the platoon dismissing message to the FV of the vehicle platoon. The LV may transmit the platoon dismissing message to the FV through a communication interface between the LV and the FV. The FV that receives the platoon dismissing message sets the status of the FV to the free state, and travels out of the vehicle platoon. The status of the FV becomes a free state, and the FV becomes a free vehicle. The FV that becomes the free vehicle may further transmit the status information of the FV to the remote control terminal. Then the remote control terminal may find a suitable vehicle platoon for the free vehicle and trigger a platoon joining process, thereby realizing flexible scheduling.

In some embodiments, based on the target vehicle being the LV, the method in some embodiments may further include transmitting, by the target vehicle based on the target vehicle determining the vehicle platoon is not to be dismissed, instruction information configured for instructing to maintain the vehicle platoon to the FV of the LV.

For example, although the LV is taken over and is under driving control by the remote control terminal, based on the LV determining the current vehicle platoon is not to be dismissed, the LV may instruct the FV to further travel based on travelling parameters transmitted by the LV. The instruction information configured for instructing to maintain the vehicle platoon may be transmitted to the FV of the LV. In some embodiments, the instruction information may not be transmitted. The FV may further travel based on the travelling parameters transmitted by the LV.

In some embodiments, based on the target vehicle being the FV, the target vehicle initiating an operation of controlling statuses of vehicles of the vehicle platoon other than the target vehicle may include the following operations:

1021′: The target vehicle transmits a leaving request message to the LV.

The leaving request message is a message configured for requesting to leave the current vehicle platoon transmitted by the target vehicle to the LV.

1022′: The target vehicle receives a platoon dismissing message transmitted by the LV.

The platoon dismissing message is a message configured for prompting the target vehicle that the target vehicle may leave the current vehicle platoon transmitted by the LV to the target vehicle, which indicates that a status of the target vehicle may be changed to a free state.

1023′: The target vehicle sets a status of the target vehicle to a free state, and travels out of the vehicle platoon.

For example, based on the FV being taken over, the FV may be under travelling control by the remote control terminal, and the FV may no longer be the member of the vehicle platoon. The FV may set the status of the FV to a free state and travel out of the vehicle platoon.

Based on receiving the leaving request message from the target vehicle, the LV may transmit the platoon dismissing message to all FVs of the vehicle platoon based on the LV determining the vehicle platoon is to be dismissed, and may transmit the platoon dismissing message to the target vehicle based on the LV determining the vehicle platoon is not to be dismissed. The target vehicle transmits the leaving request message to the LV, so that the LV may return the corresponding platoon dismissing message to the target vehicle depending on whether the vehicle platoon is to be dismissed, which realizes flexible responses to whether each FV leaves the platoon.

103: The target vehicle transmits a takeover request to the remote control terminal.

The takeover request is a message configured for requesting the remote control terminal to control the target vehicle to enter a driving state transmitted by the target vehicle to the remote control terminal.

104: The remote control terminal transmits a takeover confirmation message to the target vehicle.

The takeover confirmation message is a message configured for feeding back information about the takeover request transmitted by the remote control terminal to the target vehicle, which indicates that the remote control terminal determines to control the target vehicle to enter the driving state.

105: The remote control terminal controls the target vehicle to enter the driving state.

In some embodiments, that the remote control terminal controlling the target vehicle to enter the driving state may include:
controlling, by the remote control terminal, the target vehicle to enter the driving state based on the status information of the target vehicle.

Further, the controlling, by the remote control terminal, the target vehicle to enter the driving state based on the status information of the target vehicle, may include:
determining, by the remote control terminal, travelling information of the target vehicle based on the status information of the target vehicle;
transmitting, by the remote control terminal, the travelling information to the target vehicle; and
performing, by the target vehicle, a driving behavior based on the travelling information.

For example, the travelling information includes information such as a travelling route and a travelling speed. The target vehicle may perform the driving behavior based on the travelling route and the travelling speed transmitted by the remote control terminal.

The remote control terminal determines the travelling route and the like of the target vehicle based on the status information of the target vehicle, so that a travelling state of the target vehicle satisfies a travelling demand, which flexibly considers a vehicle status and other parameter information of the target vehicle.

In the method for controlling travelling of a vehicle platoon provided in some embodiments, the target vehicle establishes the network connection with the remote control terminal, so that the remote control terminal may obtain status information of each vehicle of the vehicle platoon. Based on the target vehicle determining the target vehicle is to be remotely taken over, the target vehicle initiates the operation of controlling the statuses of the vehicles of the vehicle platoon other than the target vehicle, and transmits the takeover request to the remote control terminal through a network, so that the remote control terminal may control the target vehicle to enter the driving state. Based on the target vehicle of the vehicle platoon being determined to be remotely taken over (for example, the target vehicle determines the target vehicle is to be remotely taken over based on encountering an emergency or requiring travelling intervention), the target vehicle requests the remote control terminal to control the target vehicle to enter the driving state, and initiates the operation of controlling the statuses of the other vehicles of the vehicle platoon. In this way, remote control of the statuses of the vehicles of the vehicle platoon through the network may be realized, so that the remote control terminal may perform flexible remote scheduling on the vehicle platoon.

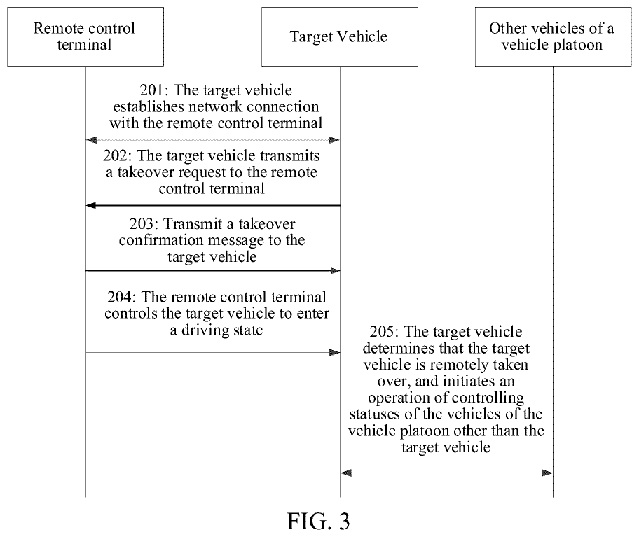

In some embodiments as illustrated in FIG. 2, the target vehicle first initiates the operation of controlling the statuses of the vehicles of the vehicle platoon other than the target vehicle, and then requests the remote control terminal to take over the target vehicle. In some embodiments, the target vehicle may request the remote control terminal to take over the target vehicle first, and then initiate the operation of controlling the statuses of the vehicles in the vehicle platoon other than the target vehicle. A description is provided below in combination with some embodiments as illustrated in FIG. 3.

FIG. 3 is an interaction flowchart of a method for controlling travelling of a vehicle platoon according to some embodiments. As shown in FIG. 3, the method may include the following operations:

201: A target vehicle establishes network connection with a remote control terminal, the target vehicle being any vehicle of the vehicle platoon.

The target vehicle is any vehicle of the vehicle platoon. Members of the vehicle platoon include an LV and an FV of the LV. The LV may be driven manually by a driver, or may be driven automatically. In the vehicle platoon, the LV performs V2X communication with the FV in a PC5 communication manner for driving as a platoon.

That the target vehicle establishes the network connection with the remote control terminal may be that the target vehicle establishes the network connection through a 4G network, a 5G network, or a next-generation wireless communication network. Based on establishing the network connection, the target vehicle may exchange data with the remote control terminal. In some embodiments, the method in some embodiments may further include:
transmitting, by the target vehicle, status information of the target vehicle to the remote control terminal. The status information, for example, may include status parameters and other attribute information of the vehicle obtained through a vehicle sensor, and may further include fused sensing information obtained by fusing data of a plurality of vehicle sensors. The data fusion includes but is not limited to processing sensing data based on aligned time and spatial coordinates to obtain more accurate and comprehensive information. The status information, for example, may include a current travelling speed and current location information.

202: The target vehicle transmits a takeover request to the remote control terminal.

For example, the target vehicle may transmit the takeover request to the remote control terminal based on the target vehicle determining the target vehicle is encountering an emergency or is requesting travelling intervention, or based on the target vehicle determining the target vehicle is having difficulty in further travelling, the target vehicle is having a malfunction or is low on fuel, or a driver of the LV is experiencing discomfort based on the target vehicle being the LV.

203: The remote control terminal transmits a takeover confirmation message to the target vehicle.

204: The remote control terminal controls the target vehicle to enter a driving state.

In some embodiments, that the remote control terminal controlling the target vehicle to enter the driving state may include:
controlling, by the remote control terminal, the target vehicle to enter the driving state based on the status information of the target vehicle.

Further, the controlling, by the remote control terminal, the target vehicle to enter the driving state based on the status information of the target vehicle may be:
determining, by the remote control terminal, travelling information of the target vehicle based on the status information of the target vehicle;
transmitting, by the remote control terminal, the travelling information to the target vehicle; and
performing, by the target vehicle, a driving behavior based on the travelling information.

For example, the travelling information includes information such as a travelling route and a travelling speed. The target vehicle may perform the driving behavior based on the travelling route and the travelling speed transmitted by the remote control terminal.

205: The target vehicle determines the target vehicle is remotely taken over, and initiates an operation of controlling statuses of vehicles of the vehicle platoon other than the target vehicle.

For example, based on the target vehicle determining the target vehicle is being remotely taken over, the vehicle platoon changes accordingly. The operation of controlling the statuses of the vehicles of the vehicle platoon other than the target vehicle is initiated, to control the statuses of the other vehicles of the vehicle platoon.

In some embodiments, based on the target vehicle being the LV, the target vehicle initiating an operation of controlling statuses of vehicles of the vehicle platoon other than the target vehicle may include the following operation:

2051: The target vehicle transmits, based on the target vehicle determining the vehicle platoon is to be dismissed, a platoon dismissing message to the FV of the LV, so that the FV that receives the platoon dismissing message sets a status of the FV to a free state, and travels out of vehicle platoon.

For example, because the LV being taken over may be caused by a special status of the LV, the LV may be no longer suitable for travelling as an LV. The vehicle platoon may be dismissed. Based on the LV determining the vehicle platoon is to be dismissed, the LV transmits the platoon dismissing message to the FV of the vehicle platoon. The LV may transmit the platoon dismissing message to the FV through a communication interface between the LV and the FV. The FV that receives the platoon dismissing message sets the status of the FV to the free state, and travels out of the vehicle platoon. The status of the FV becomes a free state, and the FV becomes a free vehicle. The FV that becomes the free vehicle may further transmit the status information of the FV to the remote control terminal. Then the remote control terminal may find a suitable vehicle platoon for the free vehicle and trigger a platoon joining process, thereby realizing flexible scheduling.

In some embodiments, based on the target vehicle being the LV, the method in some embodiments may further include transmitting, by the target vehicle based on the target vehicle determining the vehicle platoon is not to be dismissed, instruction information configured for instructing to maintain the vehicle platoon to the FV of the LV.

For example, although the LV is taken over and is under driving control by the remote control terminal, based on the LV determining the current vehicle platoon is not to be dismissed, the LV may instruct the FV to further travel based on travelling parameters transmitted by the LV. The instruction information configured for instructing to maintain the vehicle platoon may be transmitted to the FV of the LV. In some embodiments, the instruction information may not be transmitted. The FV may further travel based on the travelling parameters transmitted by the LV.

In some embodiments, based on the target vehicle being the FV, the target vehicle initiating an operation of controlling statuses of vehicles of the vehicle platoon other than the target vehicle may include the following operations:

2051′: The target vehicle transmits a leaving request message to the LV.

2052′: The target vehicle receives a platoon dismissing message transmitted by the LV.

2053′: The target vehicle sets a status of the target vehicle to a free state, and travels out of the vehicle platoon.

For example, based on the FV being taken over, the FV may be under travelling control by the remote control terminal, and the FV may no longer be the member of the vehicle platoon. The FV may set the status of the FV to a free state and travel out of the vehicle platoon.

Based on receiving the leaving request message from the target vehicle, the LV may transmit the platoon dismissing message to all FVs of the vehicle platoon based on the LV determining the vehicle platoon is to be dismissed, and may transmit the platoon dismissing message to the target vehicle based on the LV determining the vehicle platoon is not to be dismissed.

In the method for controlling travelling of a vehicle platoon provided in some embodiments, the target vehicle establishes the network connection with the remote control terminal, so that the remote control terminal may obtain the status information of each vehicle of the vehicle platoon. The target vehicle transmits the takeover request to remote control terminal through the network, so that the remote control terminal may control the target vehicle to enter the driving state. Based on the target vehicle determining the target vehicle is remotely taken over, the target vehicle initiates the operation of controlling the statuses of the vehicles of the vehicle platoon other than the target vehicle. The target vehicle of the vehicle platoon may request the remote control terminal to control the target vehicle to enter the driving state, and initiates the operation of controlling the statuses of the other vehicles of the vehicle platoon. In this way, remote control of the statuses of the vehicles of the vehicle platoon through the network may be realized, so that the remote control terminal may perform flexible remote scheduling on the vehicle platoon.

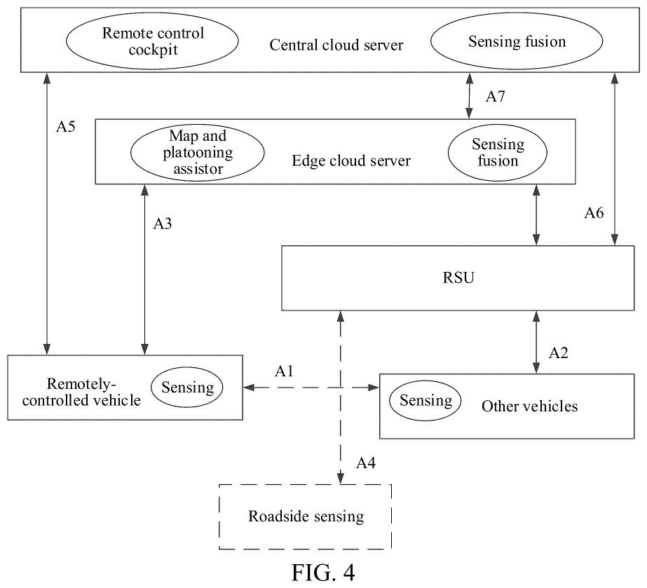

For example, FIG. 4 is a system architecture diagram of a method for controlling travelling of a vehicle platoon according to some embodiments. As shown in FIG. 4, in some embodiments, a remote control terminal is a remote control cockpit. The remote control cockpit is deployed on a central cloud server, and a map and a platooning assistor (unit) are deployed on an edge cloud server. One edge cloud server is responsible for a road segment. The central cloud server and the edge cloud server exchange data through an A7 interface. The remote control cockpit and a remotely-controlled vehicle exchange data through an A5 interface. The edge cloud server and the remotely-controlled vehicle exchange data through an A3 interface. An RSU and the edge cloud server exchange data through an A4 interface. The RSU and the central cloud server through an A6 interface. The RSU and another vehicle exchange data through an A2 interface. The remotely-controlled vehicle and the another vehicle exchange data through an A1 interface. The A1 interface may include a PC5 communication interface. The remotely-controlled vehicle forms a vehicle platoon with the another vehicle. The remotely-controlled vehicle may include an LV, or may include an FV.

The central cloud server and the edge cloud server each have a sensing fusion function, for example, may fuse data of a plurality of vehicle sensors. The data fusion includes but is not limited to processing sensing data based on aligned time and spatial coordinates to obtain more accurate and comprehensive information. The remotely-controlled vehicle and the another vehicle each have a sensing function. The vehicles may obtain status parameters and other attribute information of the vehicles through a vehicle sensor.

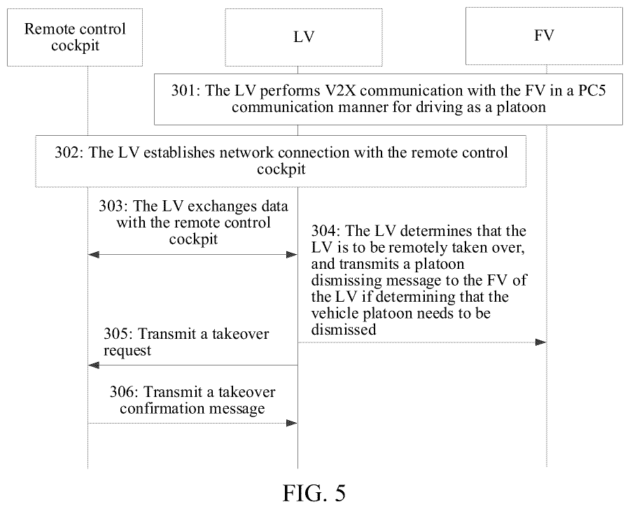

With reference to FIG. 4, FIG. 5 is an interaction flowchart of a method for controlling travelling of a vehicle platoon according to some embodiments. As shown in FIG. 5, in some embodiments, a target vehicle is an LV, for example. Members of the vehicle platoon include an LV and an FV of the LV. The method may include the following operations:

301: The LV performs V2X communication with the FV in a PC5 communication manner for driving as a platoon.

302: The LV establishes network connection with the remote control cockpit.

303: The LV exchanges data with the remote control cockpit.

For example, the LV may exchange data with the remote control cockpit through the A5 interface.

304: The LV determines the LV is to be remotely taken over, and transmits a platoon dismissing message to the FV of the LV based on the LV determining the vehicle platoon is to be dismissed.

For example, the LV may transmit the platoon dismissing message to the FV of the LV through the A1 interface.

305: The LV transmits a takeover request to the remote control cockpit.

For example, the LV may transmit the takeover request to the remote control cockpit through the A5 interface.

306: The remote control cockpit transmits a takeover confirmation message to the LV.

For example, the remote control cockpit may transmit the takeover confirmation message to the LV through the A5 interface.

So far, the LV is taken over, and the remote control cockpit controls the LV to enter a driving state. The remote control cockpit may determine travelling information based on status information of the LV, and transmit the travelling information to the LV, and the LV performs a driving behavior based on the travelling information.

The FV that receives the platoon dismissing message sets a status of the FV to the free state, and travels out of the vehicle platoon to be a free vehicle.

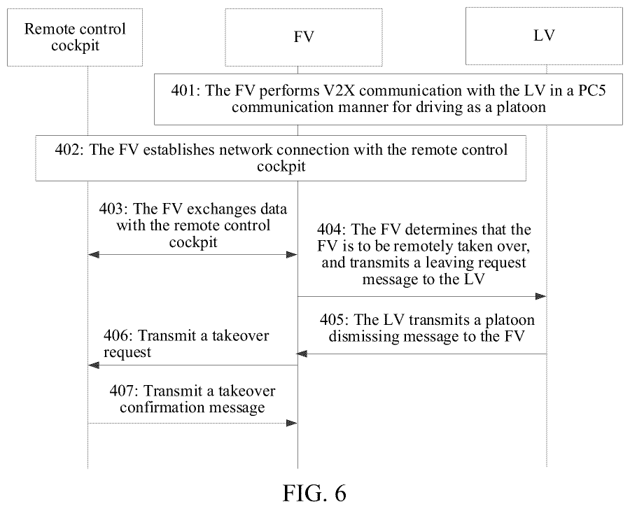

With reference to FIG. 4, FIG. 6 is an interaction flowchart of a method for controlling travelling of a vehicle platoon according to some embodiments. As shown in FIG. 6, in some embodiments, a target vehicle is an FV of a vehicle platoon, for example. The method may include the following operations:

401: The FV performs V2X communication with an LV in a PC5 communication manner for driving as a platoon.

402: The FV establishes network connection with the remote control cockpit.

403: The FV exchanges data with the remote control cockpit.

The FV may exchange data with the remote control cockpit through the A5 interface.

404: The FV determines the FV is to be remotely taken over, and transmits a leaving request message to the LV.

For example, the FV may transmit the leaving request message to the LV through the A1 interface.

405: The LV transmits a platoon dismissing message to the FV.

For example, the LV may transmit the platoon dismissing message to the FV through the A1 interface.

406: The FV transmits a takeover request to the remote control cockpit.

The FV may transmit the takeover request to the remote control cockpit through the A5 interface.

407: The remote control cockpit transmits a takeover confirmation message to the FV.

For example, the remote control cockpit may transmit the takeover confirmation message to the FV through the A5 interface.

So far, the FV is taken over, and the remote control cockpit controls the FV to enter a driving state. The remote control cockpit may determine travelling information based on status information of the FV, and transmit the travelling information to the FV, and the FV performs a driving behavior based on the travelling information.

In some embodiments, based on receiving the leaving request message transmitted by the FV, the LV may transmit the platoon dismissing message to all FVs of the vehicle platoon based on the LV determining the vehicle platoon is to be dismissed. FVs that receive the platoon dismissing message other than the FV that is taken over each set a status thereof to a free state and travel out of the vehicle platoon to become a free vehicle. Based on the LV determining the vehicle platoon is not to be dismissed, the LV may transmit the platoon dismissing message to the FV.

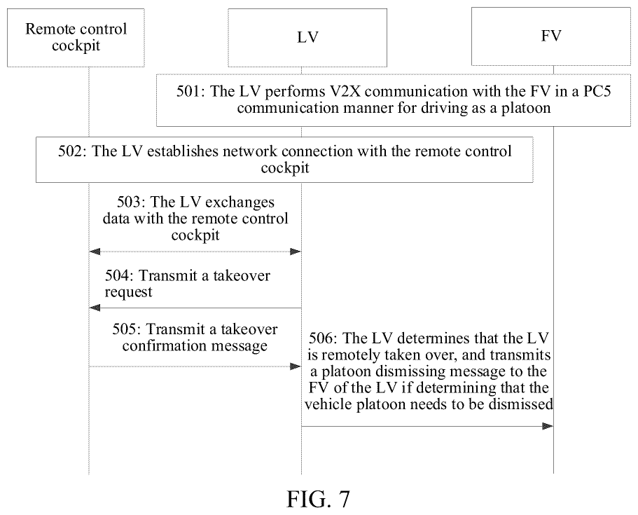

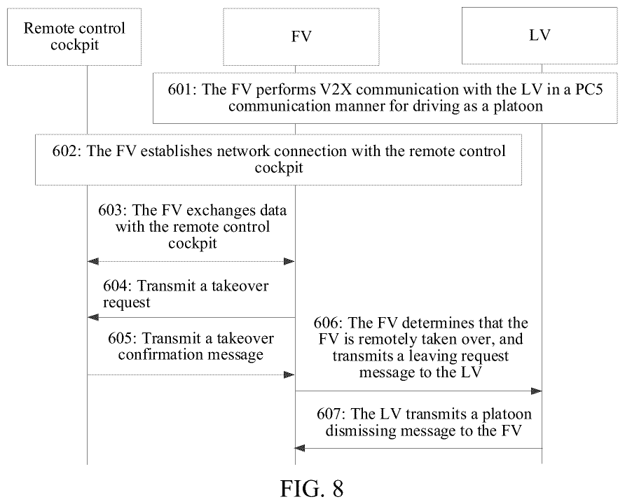

In some embodiments as illustrated in FIG. 5 and FIG. 6, the target vehicle (the LV or the FV) first initiates the operation of controlling the statuses of the vehicles of the vehicle platoon other than the target vehicle, and then requests the remote control terminal to take over the target vehicle. That the target vehicle (the LV or the FV) first requests the remote control terminal to take over the target vehicle and then initiates the operation of controlling the statuses of the vehicles of the vehicle platoon other than the target vehicle is described in detail below with reference to some embodiments as illustrated in FIG. 7 and FIG. 8.

With reference to FIG. 4, FIG. 7 is an interaction flowchart of a method for controlling travelling of a vehicle platoon according to some embodiments. As shown in FIG. 7, in some embodiments, a target vehicle is an LV, for example. The method may include the following operations:

501: The LV performs V2X communication with the FV in a PC5 communication manner for driving as a platoon.

502: The LV establishes network connection with the remote control cockpit.

503: The LV exchanges data with the remote control cockpit.

For example, the LV may exchange data with the remote control cockpit through the A5 interface.

504: The LV transmits a takeover request to the remote control cockpit.

For example, the LV may transmit the takeover request to the remote control cockpit through the A5 interface.

505: The remote control cockpit transmits a takeover confirmation message to the LV.

For example, the remote control cockpit may transmit the takeover confirmation message to the LV through the A5 interface.

506: The LV determines the LV is remotely taken over, and transmits a platoon dismissing message to the FVs of the LV based on the LV determining the vehicle platoon is to be dismissed.

For example, the LV may transmit the platoon dismissing message to the FV of the LV through the A1 interface.

So far, the LV is taken over, and the remote control cockpit controls the LV to enter a driving state. The remote control cockpit may determine travelling information based on status information of the LV, and transmit the travelling information to the LV, and the LV performs a driving behavior based on the travelling information.

The FV that receives the platoon dismissing message sets a status of the FV to the free state, and travels out of the vehicle platoon to be a free vehicle.

With reference to FIG. 4, FIG. 8 is an interaction flowchart of a method for controlling travelling of a vehicle platoon according to some embodiments. As shown in FIG. 8, in some embodiments, a target vehicle is an FV of a vehicle platoon, for example. The method may include the following operations:

601: The FV performs V2X communication with an LV in a PC5 communication manner for driving as a platoon.

602: The FV establishes network connection with the remote control cockpit.

603: The FV exchanges data with the remote control cockpit.

For example, the FV may exchange data with the remote control cockpit through the A5 interface.

604: The FV transmits a takeover request to the remote control cockpit.

For example, the FV may transmit the takeover request to the remote control cockpit through the A5 interface.

605: The remote control cockpit transmits a takeover confirmation message to the FV.

For example, the remote control cockpit may transmit the takeover confirmation message to the FV through the A5 interface.

606: The FV determines the FV is remotely taken over, and transmits a leaving request message to the LV.

For example, the FV may transmit the leaving request message to the LV through the A1 interface.

607: The LV transmits a platoon dismissing message to the FV.

For example, the LV may transmit the platoon dismissing message to the FV through the A1 interface.

So far, the FV is taken over, and the remote control cockpit controls the FV to enter a driving state. The remote control cockpit may determine travelling information based on status information of the FV, and transmit the travelling information to the FV, and the FV performs a driving behavior based on the travelling information.

In some embodiments, based on receiving the leaving request message transmitted by the FV, the LV may transmit the platoon dismissing message to all FVs of the vehicle platoon based on the LV determining that the vehicle platoon is to be dismissed. FVs that receive the platoon dismissing message other than the FV that is taken over each set a status thereof to a free state and travel out of the vehicle platoon to become a free vehicle. Based on the LV determining the vehicle platoon is not to be dismissed, the LV may transmit the platoon dismissing message to the FV.

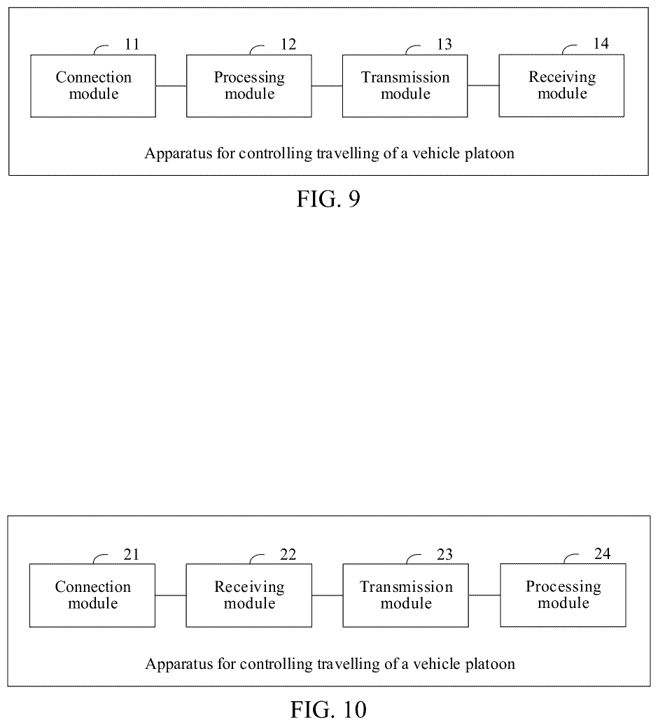

FIG. 9 is a schematic structural diagram of an apparatus for controlling travelling of a vehicle platoon according to some embodiments. As shown in FIG. 9, the apparatus may include a connection module 11, a processing module 12, a transmission module 13, and a receiving module 14.

The connection module 11 may be configured to establish network connection with a remote control terminal. The apparatus for controlling travelling of a vehicle platoon may include an apparatus for controlling travelling of a vehicle platoon of any vehicle of the vehicle platoon.

The processing module 12 may be configured to determine that a target vehicle is to be remotely taken over, and initiate an operation of controlling statuses of vehicles of the vehicle platoon other than the target vehicle.

The transmission module 13 may be configured to transmit a takeover request to the remote control terminal, so that the remote control terminal controls the target vehicle to enter a driving state.

The receiving module 14 may be configured to receive a takeover confirmation message transmitted by the remote control terminal.

In some embodiments, the target vehicle is an LV. The processing module 12 may be configured to:
transmit, based on the processing module determining the vehicle platoon is to be dismissed, a platoon dismissing message to the FV of the LV, so that the FV that receives the platoon dismissing message sets a status of the FV to a free state, and travels out of the vehicle platoon.

In some embodiments, the processing module 12 is further configured to transmit, based on the processing module determining the vehicle platoon is not to be dismissed, instruction information configured for instructing to maintain the vehicle platoon to the FV of the LV.

In some embodiments, the target vehicle is an FV. The transmission module 13 may be configured to transmit a leaving request message to an LV.

The receiving module 14 may be configured to receive a platoon dismissing message transmitted by the LV.

The processing module 12 may be configured to set a status of the FV to a free state, and travel out of the vehicle platoon.

In some embodiments, the transmission module 13 is further configured to transmit status information of the target vehicle to the remote control terminal. The receiving module 14 may be configured to receive travelling information transmitted by the remote control terminal. The processing module 12 may be configured to perform a driving behavior based on the travelling information, the travelling information being determined by the remote control terminal based on the status information of the target vehicle.

FIG. 10 is a schematic structural diagram of an apparatus for controlling travelling of a vehicle platoon according to some embodiments. As shown in FIG. 10, the apparatus may include a connection module 21, a receiving module 22, a transmission module 23, and a processing module 24. The connection module 21 may be configured to establish network connection with a target vehicle, the target vehicle being any vehicle of the vehicle platoon.

The receiving module 22 may be configured to receive a takeover request transmitted by the target vehicle.

The transmission module 23 may be configured to transmit a takeover confirmation message to the target vehicle.

The processing module 24 may be configured to control the target vehicle to enter a driving state.

In some embodiments, the receiving module 22 is further configured to receiving status information of the target vehicle transmitted by the target vehicle. The processing module 24 may be configured to control the target vehicle to enter a driving state based on the status information of the target vehicle.

In some embodiments, the processing module 24 may be configured to determine travelling information of the target vehicle based on the status information of the target vehicle.

The transmission module 23 may be configured to transmit the travelling information to the target vehicle, so that the target vehicle performs a driving behavior based on the travelling information.

The apparatus and the method may correspond to each other, and for similar descriptions, reference may be made to the method. The apparatus for controlling travelling of a vehicle platoon shown in FIG. 9 may perform the method according to some embodiments corresponding to the target vehicle, and the above and other operations and/or functions of the modules in the apparatus shown in FIG. 9 are respectively configured to implement the method according to some embodiments corresponding to the target vehicle. The apparatus for controlling travelling of a vehicle platoon shown in FIG. 10 may perform the method according to some embodiments corresponding to the remote control terminal, and the above and other operations and/or functions of the modules in the apparatus shown in FIG. 10 are respectively configured to implement the method according to some embodiments corresponding to the remote control terminal.

The apparatus for controlling travelling of a vehicle platoon in some embodiments is described above from the perspective of functional modules with reference to the drawings. The functional modules may be implemented in a form of hardware, or may be implemented by instructions in a form of software, or may be implemented by a combination of hardware and software modules. The operations of the method according to some embodiments may be completed by using an integrated logic circuit of hardware in a processor and/or instructions in a form of software. The operations of the methods according to some embodiments may be directly performed and completed by a hardware decoding processor, or may be performed and completed by a combination of hardware and software modules in the decoding processor. In some embodiments, the software module may be located in a mature storage medium in the art, such as a random access memory (RAM), a flash memory, a read-only memory (ROM), a programmable read-only memory (PROM), an electrically erasable programmable memory (EEPROM), or a register. The storage medium is located in the memory. The processor reads information in the memory and completes the operations of some embodiments in combination with hardware of the processor.

According to some embodiments, each module or unit may exist respectively or be combined into one or more units. Some units may be further split into multiple smaller function subunits, thereby implementing the same operations without affecting the technical effects of some embodiments. The units are divided based on logical functions. In application, a function of one unit may be realized by multiple units, or functions of multiple units may be realized by one unit. In some embodiments, the apparatus may further include other units. In application, these functions may also be realized cooperatively by the other units, and may be realized cooperatively by multiple units.

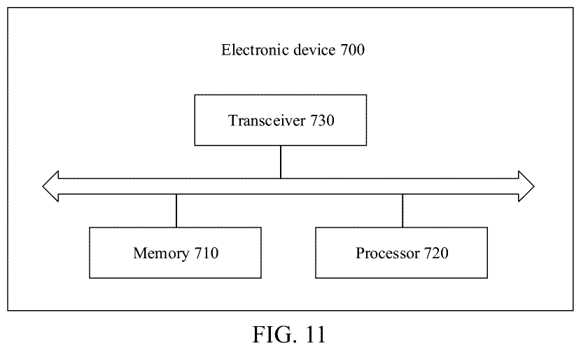

FIG. 11 is a schematic block diagram of an electronic device 700 according to some embodiments.

As shown in FIG. 11, the electronic device 700 may include a memory 710 and a processor 720. The memory 710 may be configured to store a computer program and transmit program code to the processor 720. The processor 720 may invoke the computer program from the memory 710 and execute the computer program, to implement the method in some embodiments.

For example, the processor 720 may be configured to perform some embodiments based on instructions in the computer program.

In some embodiments, the processor 720 may include but is not limited to
a general-purpose processor, a digital signal processor (DSP), an application specific integrated circuit (ASIC), a field programmable gate array (FPGA), or another programmable logic device, a discrete gate or a transistor logic device, and a discrete hardware component.

In some embodiments, the memory 710 includes but is not limited to
a volatile memory and/or a nonvolatile memory. The nonvolatile memory may include a ROM, a PROM, an erasable programmable read-only memory (EPROM), an EEPROM, or a flash memory. The volatile memory may include a RAM, and serves as an external cache. By way of example and not limitation, many forms of RAMs, such as a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct rambus random access memory (DR RAM) may be used.

In some embodiments, the computer program may be divided into one or more modules, and the one or more modules are stored in the memory 710 and executed by the processor 720 to complete the methods provided in some embodiments. The one or more modules may include a series of computer program instruction segments that may implement specific functions. The instruction segments are configured for describing an execution process of the computer program in the electronic device.

As shown in FIG. 11, the electronic device may further include
a transceiver 730. The transceiver 730 may be connected to the processor 720 or the memory 710.

The processor 720 may control the transceiver 730 to communicate with another device. The transceiver may transmit information or data to the another device, or receive information or data transmitted by the another device. The transceiver 730 may include a transmitter and a receiver. The transceiver 730 may further include one or more antennas.

Components in the electronic device are connected through a bus system. In addition to a data bus, the bus system further includes a power bus, a control bus, and a status signal bus.

Further provided is a computer storage medium, including instructions (or a computer program), the instructions, when run on a computer, causing the computer to perform the methods of some embodiments. Some embodiments further provides a computer program product including instructions (or a computer program), the instructions (or the computer program), when executed by a computer, causing the computer to perform the methods of some embodiments. In some embodiments, “a computer program,” “an instruction,” “a computer instruction,” “a computer program instruction,” and the like express the same meaning, which are programs or instructions that may be executed by a processor of a computer.

When some embodiments are implemented by using software, all or some of the embodiments may be implemented in a form of a computer program product. The computer program product includes one or more computer instructions. When the computer program instructions are loaded and executed on a computer, all or some of the processes or functions according to some embodiments are generated. The computer may include a general-purpose computer, a dedicated computer, a computer network, or another programmable apparatus. The computer instructions may be stored in a computer-readable storage medium, or may be transmitted from a computer-readable storage medium to another computer-readable storage medium. For example, the computer instructions may be transmitted from a website, a computer, a server, or a data center to another website, computer, server, or data center in a wired manner (for example, through a coaxial cable, an optical fiber, or a digital subscriber line (DSL)) or a wireless manner (for example, in an infrared, radio, or microwave manner). The computer-readable storage medium may include any usable medium accessible by a computer, or may include a data storage device such as a server or a data center in which one or more usable mediums are integrated. The usable medium may include a magnetic medium (such as a floppy disk, a hard disk, or a magnetic tape), an optical medium (such as a digital video disc (DVD)), a semiconductor medium (such as, a solid state disk (SSD)), or the like.

In some embodiments, a system for controlling travelling of a vehicle platoon is provided, including a target vehicle and a remote control terminal, the target vehicle being configured to perform the above method of the target vehicle side, and the remote control terminal being configured to perform the above method of the remote control terminal side.

A person of ordinary skill in the art is aware that, units, algorithms, and operations described in the examples described with reference to some embodiments may be implemented by electronic hardware or a combination of computer software and electronic hardware. Whether the functions are performed by hardware or software depends on an application and design constraints. A person skilled in the art may use different methods to implement the described functions for each application, but it is not considered that such implementation goes beyond the scope of the disclosure.

In some embodiments, the system, apparatus, and method may be implemented in another manner. For example, the described apparatus is merely an example. moreover, division into the modules is merely logical functional division and may include other divisions in application. For example, a plurality of modules or components may be combined or integrated into another system, or some features may be ignored or not performed. In addition, the displayed or discussed mutual coupling or direct coupling or communication connection may be implemented through some interfaces. The indirect coupling or communication connection between the apparatuses or modules may be implemented in an electronic, mechanical, or another form.

The modules described as separate components may or may not be physically separated, and the components displayed as modules may or may not be physical modules, and may be located in one place or may be distributed over a plurality of network units. Some or all of the modules may be selected based on demands to achieve the objectives of the solutions of the embodiments. For example, the functional modules in some embodiments may be integrated into one processing module, or the functional modules may exist alone physically, or two or more modules may be integrated into one module.

The foregoing embodiments are used for describing, instead of limiting the technical solutions of the disclosure. A person of ordinary skill in the art shall understand that although the disclosure has been described in detail with reference to the foregoing embodiments, modifications can be made to the technical solutions described in the foregoing embodiments, or equivalent replacements can be made to some technical features in the technical solutions, provided that such modifications or replacements do not cause the essence of corresponding technical solutions to depart from the spirit and scope of the technical solutions of the embodiments of the disclosure and the appended claims.

What is claimed is:

1. A method for controlling travelling of a vehicle platoon, the method comprising:
establishing, by a target vehicle of the vehicle platoon, a network connection with a remote control terminal;
determining, by the target vehicle, that the target vehicle is to be remotely taken over;
initiating, by the target vehicle, control of a plurality of statuses of a plurality of vehicles of the vehicle platoon other than the target vehicle;
transmitting, by the target vehicle, a takeover request to the remote control terminal,
controlling, by the remote control terminal, the target vehicle to enter a driving state; and
receiving, by the target vehicle, a takeover confirmation message transmitted by the remote control terminal,
wherein the plurality of vehicles include a leading vehicle (LV) and a following vehicle (FV) of the LV.

2. The method according to claim 1, wherein the target vehicle is the LV, and
wherein the initiating the control of the plurality of statuses comprises:
transmitting, by the target vehicle, a platoon dismissing message to the FV based on the target vehicle determining the vehicle platoon is to be dismissed;
receiving, by the FV, the platoon dismissing message;
setting, by the FV, a status of the FV to a free state; and
traveling, by the FV, out of the vehicle platoon.

3. The method according to claim 1, wherein the target vehicle is the FV, and
wherein the initiating the control of the plurality of statuses comprises:
transmitting, by the target vehicle, a leaving request message to the LV;
receiving, by the target vehicle, a platoon dismissing message transmitted by the LV;
setting, by the target vehicle, a status of the target vehicle to a free state; and
travelling, by the target vehicle, out of the vehicle platoon.

4. The method according to claim 1, further comprising:
transmitting, by the target vehicle, status information of the target vehicle to the remote control terminal;
determining, by the remote control terminal, traveling information based on the status information;
receiving, by the target vehicle, the travelling information transmitted by the remote control terminal; and
performing, by the target vehicle, a driving behavior based on the travelling information.

5. An apparatus for controlling travelling of a vehicle platoon, the apparatus comprising:
at least one memory configured to store computer program code; and
at least one processor configured to read the program code and operate as instructed by the program code, the program code comprising:
connection code, configured to cause at least one of the at least one processor to establish network connection with a remote control terminal;
processing code, configured to cause at least one of the at least one processor to:
determine that a target vehicle of the vehicle platoon is to be remotely taken over; and
initiate control of a plurality of statuses of a plurality of vehicles of the vehicle platoon other than the target vehicle;
first transmission code, configured to cause at least one of the at least one processor to transmit a takeover request to the remote control terminal; and
first receiving code, configured to cause at least one of the at least one processor to receive a takeover confirmation message transmitted by the remote control terminal,
wherein the remote control terminal is configured to control the target vehicle to enter a driving state based on the takeover request, and
wherein the plurality of vehicles comprise a leading vehicle (LV) and a following vehicle (FV) of the LV.

6. The apparatus according to claim 5, wherein the target vehicle is the LV,
wherein the processing code is further configured to cause at least one of the at least one processor to transmit a platoon dismissing message to the FV, and
wherein the FV is configured to set a status of the FV to a free state and travel out of the vehicle platoon, based on receiving the platoon dismissing message.

7. The apparatus according to claim 5, wherein the target vehicle is the FV,
wherein the processing code is further configured to cause at least one of the at least one processor to:
transmit a leaving request message to the LV,
receive a platoon dismissing message transmitted by the LV; and
set a status of the target vehicle to a free state, and
wherein the target vehicle is configured to travel out of the vehicle platoon based on the status being set to the free state.

8. The apparatus according to claim 5, wherein the program code further comprises:
second transmission code configured to cause at least one of the at least one processor to transmit status information of the target vehicle to the remote control terminal;
second receiving code configured to cause at least one of the at least one processor to receive travelling information transmitted by the remote control terminal; and
performing code configured to cause at least one of the at least one processor to control a driving behavior of the target vehicle based on the travelling information, and
wherein the remote control terminal is configured to determine the travelling information based on the status information.

9. A non-transitory computer-readable storage medium, storing computer code which, when executed by at least one processor, causes the at least one processor to at least:
establish network connection with a remote control terminal;
determine that a target vehicle of a vehicle platoon is to be remotely taken over;
initiate control of a plurality of statuses of a plurality of vehicles of the vehicle platoon other than the target vehicle;
transmit a takeover request to the remote control terminal; and
receive a takeover confirmation message transmitted by the remote control terminal,
wherein the remote control terminal is configured to control the target vehicle to enter a driving state based on the takeover request, and
wherein the plurality of vehicles comprise a leading vehicle (LV) and a following vehicle (FV) of the LV.

10. The non-transitory computer-readable storage medium, according to claim 9, wherein the target vehicle is the LV,
wherein the initiating the control of the plurality of statuses comprises transmitting a platoon dismissing message to the FV, and
wherein the FV is configured to set a status of the FV to a free state and travel out of the vehicle platoon, based on receiving the platoon dismissing message.

11. The non-transitory computer-readable storage medium, according to claim 9, wherein the target vehicle is the FV,
wherein the initiating the control of the plurality of statuses comprises:
transmitting a leaving request message to the LV,
receiving a platoon dismissing message transmitted by the LV; and
setting a status of the target vehicle to a free state, and
wherein the target vehicle is configured to travel out of the vehicle platoon based on the status being set to the free state.

12. The non-transitory computer-readable storage medium, according to claim 9, further comprising:
transmitting status information of the target vehicle to the remote control terminal;
receiving travelling information transmitted by the remote control terminal; and
controlling a driving behavior of the target vehicle based on the travelling information,
wherein the remote control terminal is configured to determine the travelling information based on the status information.
